(19) United States
(12) Patent Application Publication
(10) Pub. No.: US 2004/0257500 A1
(43) Pub. Date: Dec. 23, 2004

(54) Liquid crystal display

(75) Inventors: Jang-Soo Kim, Suwon-si (KR); Shi-Yul Kim, Yongin-si (KR)

Correspondence Address: MacPherson Kwok Chen & Heid LLP, Suite 226, 1762 Technology Drive, San Jose, CA, 95110, US

(73) Assignee: Samsung Electronics Co., Ltd., Suwon-si (KR)

(21) Appl. No.: 10/875,966

(22) Filed: Jun. 23, 2004

(30) Foreign Application Priority Data
Jun. 23, 2003 (KR) 2003-40710

(51) Int. Cl. G02F 1/1335

(52) U.S. Cl. 349/106

(57) ABSTRACT

A display device including a thin film transistor array panel and a liquid crystal display are disclosed. A first panel includes a plurality of signal lines and color filter stripes which are configured to overlap and thus block light leakage near the edges of the color filter stripes in a black state, thereby improving contrast ratio. A liquid crystal display includes the first panel and a second panel, which includes a substrate and a common electrode.

### BACKGROUND

(a) Field of the Invention

The present invention relates to a liquid crystal display.

(b) Description of Related Art

Liquid crystal displays (LCDs) are one of the most widely used flat panel displays. An LCD includes two panels having field-generating electrodes with a gap interposed between the panels. A liquid crystal (LC) layer fills the gap between the panels. The LCD displays images by applying voltages to the field-generating electrodes to generate an electric field in the LC layer, which determines orientations of LC molecules in the LC layer to adjust polarization of incident light.

The LCD includes a plurality of pixels arranged in a matrix and a plurality of signal lines for driving the pixels such as gate lines for transmitting scanning signals and data lines for transmitting data signals. Each pixel includes a pixel electrode, a color filter, and a thin film transistor (TFT) connected to the gate lines and the data lines for controlling the data signals.

Typically, one of the panels of the LCD includes the gate lines, the data lines, the pixel electrodes, and the TFTs, and the other panel includes the color filters for color representation and a black matrix for blocking light leakage between the pixels to improve contrast ratio. The black matrix has a large width in consideration of the alignment error range between the panels and thus it reduces aperture ratio.

The panels are made by several processes such as film deposition on a substrate and etch with photolithography using a mask. These processes are usually performed at a high temperature. Accordingly, in order to minimize the alignment error range, the characteristics of the panel substrates are preferably equal to each other such that during the manufacturing process, the thermal or chemical deformation between the panels is approximately equal.

However, obtaining the same substrate characteristics for both panels makes it difficult to reduce the production cost of the LCD.

### SUMMARY

A display device including a thin film transistor array panel and a liquid crystal display are disclosed. A first panel includes a plurality of signal lines and color filter stripes which are configured to overlap and thus block light leakage near the edges of the color filter stripes in a black state, thereby improving contrast ratio. A liquid crystal display includes the first panel and a second panel, which includes a substrate and a common electrode.

Advantageously, the substrates of the two panels can have different physical and chemical characteristics, and therefore, one of the substrates, in particular, the common electrode substrate, can be selected or configured to have minimized cost.

In accordance with one embodiment of the present invention, a display device panel is provided, including a pixel electrode, a transistor operably coupled to the pixel electrode, a plurality of signal lines operably coupled to the transistor, and a plurality of color filter stripes provided between the pixel electrode and the transistor, wherein the plurality of signal lines and color filter stripes are configured as a black matrix for blocking light leakage between pixels.

In accordance with another embodiment of the present invention, a thin film transistor array panel is provided, including an insulating substrate, a thin film transistor formed over the insulating substrate, and a pixel electrode coupled to the transistor. The panel further includes at least one gate line coupled to the transistor for transmitting gate signals to the pixel electrode, wherein the at least one gate line extends substantially in a first direction, and at least one data line coupled to the transistor for transmitting data voltages to the pixel electrode, wherein the at least one data line extends substantially in a second direction thereby intersecting the at least one gate line. At least two color filter stripes overlap each other along the at least one data line to block light leakage near a pixel area in a black state.

In accordance with yet another embodiment, a liquid crystal display (LCD) is provided, including the display device panel as disclosed above, a second panel including a second insulating substrate and a common electrode, and a liquid crystal layer between the display device panel and the second panel.

### BRIEF DESCRIPTION OF THE DRAWINGS

The present invention will become more apparent by describing embodiments thereof in detail with reference to the accompanying drawings in which:

FIG. 1 is a layout view of a TFT array panel for an LCD according to an embodiment of the present invention;

FIG. 2 is a sectional view of an LCD including the TFT array panel shown in FIG. 1 taken along the line II-II′;

FIG. 3 is a layout view of a TFT array panel for an LCD according to another embodiment of the present invention;

FIG. 4 is a sectional view of the TFT array panel shown in FIG. 3 taken along the line IV-IV′; and

FIG. 5 is a sectional view of the TFT array panel shown in FIG. 3 taken along the line V-V′.

Embodiments of the present invention and their advantages are best understood by referring to the detailed description that follows. It should be appreciated that like reference numerals are used to identify like elements illustrated in one or more of the figures.

### DETAILED DESCRIPTION

The present invention now will be described more fully hereinafter with reference to the accompanying drawings, in which preferred embodiments of the invention are shown. The present invention may, however, be embodied in many different forms and should not be construed as limited to the embodiments set forth herein.

In the drawings, the thickness of layers, films, and regions are exaggerated for clarity. Like numerals refer to like elements throughout. It will be understood that when an element such as a layer, film, region, or substrate is referred to as being “on” another element, it can be directly on the other element or intervening elements may also be present. In contrast, when an element is referred to as being “directly on” another element, there are no intervening elements present.

Liquid crystal displays in accordance with the present invention will now be described with reference to the accompanying drawings.

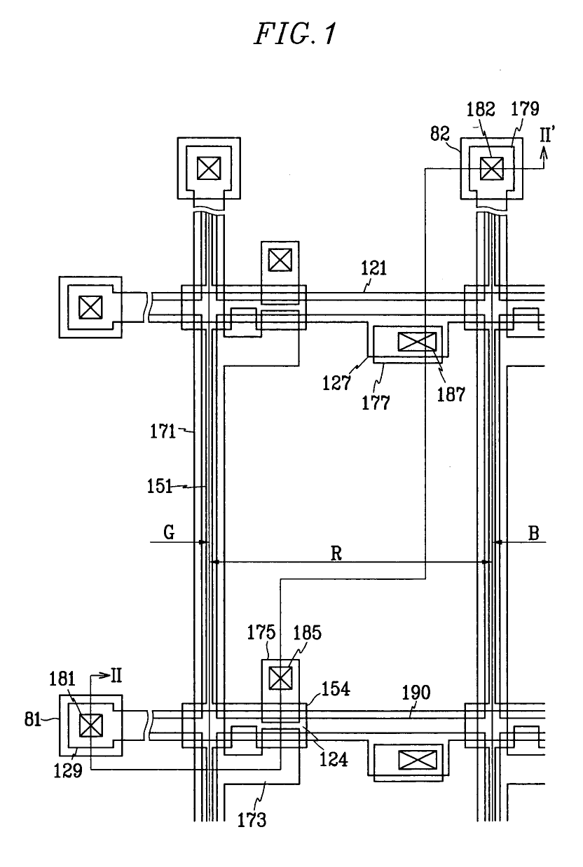

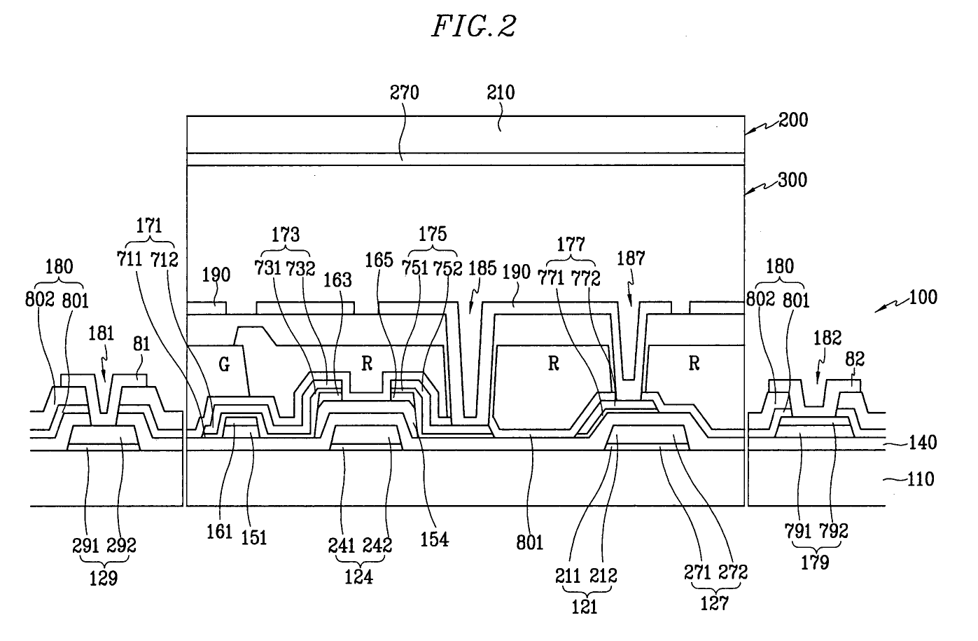

An LCD according to an embodiment of the present invention is described in detail with reference to FIGS. 1 and 2. FIG. 1 is a layout view of a TFT array panel for an LCD according to an embodiment of the present invention, and FIG. 2 is a sectional view of an LCD including the TFT array panel shown in FIG. 1 taken along the line II-II′.

An LCD according to an embodiment of the present invention includes a TFT array panel 100, a common electrode panel 200 facing the TFT array panel 100 with a predetermined gap, and a liquid crystal (LC) layer 300 filling the gap between the TFT array panel 100 and the common electrode panel 200. The LC molecules change their orientations depending on the strength of the electric field exerted on the LC layer 300 and the orientations of the LC molecules determine transmittance of incident light. The LC molecules may be aligned in a vertically aligned (VA) mode, a twisted nematic (TN) mode, or an optically compensated bend (OCB) mode.

The LCD further includes: alignment layers (not shown) for aligning LC molecules in the LC layer 300 which may be coated on inner surfaces of the panels 100 and 200; polarizers (not shown) attached on outer surfaces of the panels 100 and 200; and compensation films (not shown) for compensating the phase of light passing through the LC layer 300. The transmissive axes of the polarizers may be crossed or parallel.

The TFT array panel 100 includes a substrate 110 preferably made of insulating material such as transparent glass, a plurality of TFTs disposed on the substrate 110, a plurality of pixel electrodes 190 disposed on the substrate 110, preferably made of transparent conductive material such as indium tin oxide (ITO) or indium zinc oxide (IZO), and connected to the TFTS. The TFTs selectively transmit data voltages to the pixel electrodes 190.

The common electrode panel 200 includes a substrate 210 preferably made of transparent insulating material such as glass, and a common electrode 270 preferably made of transparent conductive material such as ITO or IZO. In accordance with the present invention, the substrate 210 may have different physical and chemical characteristics from the substrate 110, including but not limited to a different concentration, composition, composition rate, and thickness.

The TFT array panel 100 is now described more in detail.

A plurality of gate lines 121 for transmitting gate signals are formed on an insulating substrate 110. Each gate line 121 extends substantially in a transverse direction and a plurality of portions of each gate line 121 form a plurality of gate electrodes 124. Each gate line 121 includes a plurality of expansions 127 protruding downward and an end portion 129 having a large area for contact with another layer or an external device.

The gate lines 121 include two films having different physical characteristics, a lower film 211 and an upper film 212. The lower film 211 is preferably made of low resistivity metal including Al containing metal such as Al and/or Al alloy for reducing signal delay or voltage drop in the gate lines 121. On the other hand, the upper film 212 is preferably made of material such as Cr, Mo, and/or Mo alloy having good contact characteristics with other materials such as ITO or IZO. A good exemplary combination of the lower film material and the upper film material is Cr and Al—Nd alloy.

In FIG. 2, the lower and the upper films of the gate electrodes 124 are indicated by reference numerals 241 and 242, respectively, the lower and the upper films of the expansion 127 are indicated by reference numerals 271 and 272, respectively, and the lower and the upper films of the end portions 129 are indicated by reference numerals 291 and 292, respectively. The lateral sides of the upper film and the lower film are inclined relative to a surface of the substrate 110, and the inclination angle thereof ranges between about 30 degrees and about 80 degrees.

A gate insulating layer 140 preferably made of silicon nitride (SiNx) is formed on the gate lines 121.

A plurality of semiconductor stripes 151 preferably made of hydrogenated amorphous silicon (abbreviated as “a-Si”) are formed on the gate insulating layer 140. Each semiconductor stripe 151 extends substantially in a longitudinal direction and has a plurality of projections 154 branched out toward the gate electrodes 124. The width of each semiconductor stripe 151 becomes large near the gate lines 121 such that the semiconductor stripe 151 covers large areas of the gate lines 121.

A plurality of ohmic contact stripes and islands 161 and 165 preferably made of silicide or n+ hydrogenated a-Si heavily doped with n-type impurity are formed on the semiconductor stripes 151. Each ohmic contact stripe 161 has a plurality of projections 163, and the projections 163 and the ohmic contact islands 165 are located in pairs on the projections 154 of the semiconductor stripes 151.

The lateral sides of the semiconductor stripes 151 and the ohmic contacts 161 and 165 are tapered, and the inclination angles thereof are preferably in a range between about 30-80 degrees.

A plurality of data lines 171, a plurality of drain electrodes 175, and a plurality of storage capacitor conductors 177 are formed on the ohmic contacts 161 and 165 and the gate insulating layer 140, respectively.

The data lines 171 for transmitting data voltages extend substantially in the longitudinal direction and intersect the gate lines 121. A plurality of branches of each data line 171, which project toward the drain electrodes 175, form a plurality of source electrodes 173, and each data line 171 has an end portion 179 having a large area for contact with another layer or an external device. Each drain electrode 175 is separated from the data lines 171 and disposed opposite a source electrode 173 with respect to a gate electrode 124. A gate electrode 124, a source electrode 173, and a drain electrode 175 along with a projection 154 of a semiconductor stripe 151 form a TFT having a channel formed in the projection 154 disposed between the source electrode 173 and the drain electrode 175.

The storage capacitor conductors 177 overlap the expansions 127 of the gate lines 121.

The data lines 171, the drain electrodes 175, and the storage capacitor conductors 177 each include two films having different physical characteristics, a lower film 711, 751, and 771, respectively, and an upper film 712, 752, and 772, respectively. The lower film 711, 751, and 771 is preferably made of low resistivity metal including Al containing metal such as Al and Al alloy for reducing signal delay or voltage drop in the data lines 171. On the other hand, the upper film 712, 752 and 772 is preferably made of material such as Cr, Mo and Mo alloy having good contact characteristics with other materials such as ITO or IZO.

Like the gate lines 121, the data lines 171, the drain electrodes 175, and the storage capacitor conductors 177 have tapered lateral sides, and the inclination angles thereof range between about 30 degrees and about 80 degrees.

The ohmic contacts 161 and 165 are interposed only between the underlying semiconductor stripes 151 and the overlying data lines 171 and the overlying drain electrodes 175 thereon and reduce the contact resistance therebetween. The semiconductor stripes 151 include a plurality of exposed portions, which are not covered with the data lines 171 and the drain electrodes 175, such as portions located between the source electrodes 173 and the drain electrodes 175. Although the semiconductor stripes 151 are narrower than the data lines 171 at most places, the width of the semiconductor stripes 151 becomes large near the gate lines as described above, to smooth the profile of the surface, thereby preventing the disconnection of the data lines 171.

A first passivation layer 801 preferably made of silicon nitride or silicon oxide is formed on the data lines 171, the drain electrodes 175, the storage conductors 177, and the exposed portions of the semiconductor stripes 151.

A plurality of red, green, and blue color filter stripes R, G, and B are formed on the first passivation layer 801. Each of the color filter stripes R, G, and B are disposed substantially between two of the data lines 171 and extends in a longitudinal direction. The color filter stripes R, G, and B are not disposed on a peripheral area which is provided with the expansions 129 and 179 of the gate lines 121 and the data lines 171, respectively. Edges of adjacent color filter stripes R, G, and B overlap each other, and the edges may be thinner than other portions for improving step coverage of overlying layers and for planarizing a surface to prevent misalignment of the LC molecules. It is preferable that the overlapping portions fully cover the data lines 171.

The adjacent color filter stripes R, G, and B represent different colors such that the overlapping portions thereof block the light leakage near the edges of the color filter stripes R, G, and B in a black state, thereby improving contrast ratio. Accordingly, the gate lines 121, the data lines 171, and the color filter stripes R, G, and B serve as a black matrix for blocking the light leakage near pixel areas.

A second passivation layer 802 is formed on the adjacent color filter stripes R, G, and B. The second passivation layer 802 is preferably made of photosensitive organic material having a good flatness characteristic or low dielectric insulating material such as a-Si:C:O and a-Si:O:F formed by plasma enhanced chemical vapor deposition (PECVD).

The passivation layers 801 and 802 have a plurality of contact holes 182, 185, and 187 exposing the end portions 179 of the data lines 171, the drain electrodes 175, and the storage conductors 177, respectively. In addition, the passivation layers 801 and 802 and the gate insulating layer 140 have a plurality of contact holes 181 exposing the end portions 129 of the gate lines 121. The color filter stripes R, G, and B have a plurality of openings on the drain electrodes 175 and the storage conductors 177, which are larger than the contact holes 185 and 187. However, the contact holes 185 and 187 expose a top surface of the color filter stripes R, G, and B to have stepped profiles.

A plurality of pixel electrodes 190 and a plurality of contact assistants 81 and 82, which are preferably made of transparent conductive material such as ITO and IZO or reflective conductive material such as Al and Ag, are formed on the passivation layer 180.

The pixel electrodes 190 are physically and electrically connected to the drain electrodes 175 through the contact holes 185 and to the storage capacitor conductors 177 through the contact holes 187 such that the pixel electrodes 190 receive the data voltages from the drain electrodes 175 and transmit the received data voltages to the storage capacitor conductors 177. The pixel electrodes 190 supplied with the data voltages generate electric fields in cooperation with common electrode 270 on the common electrode panel 200, which reorient LC molecules in the LC layer 300 disposed therebetween.

The pixel electrode 190 and the common electrode 270 form a LC capacitor C_{LC}, which stores applied voltages after turn-off of the TFT Q. An additional capacitor called a “storage capacitor,” which is connected in parallel to the LC capacitor C_{LC}, is provided for enhancing the voltage storing capacity. The storage capacitors are implemented by overlapping the pixel electrodes 190 with the gate lines 121 adjacent thereto (called “previous gate lines”). The capacitances of the storage capacitors, i.e., the storage capacitances, are increased by providing the expansions 127 at the gate lines 121 for increasing overlapping areas and by providing the storage capacitor conductors 177, which are connected to the pixel electrodes 190 and overlap the expansions 127, under the pixel electrodes 190 for decreasing the distance between the terminals. Otherwise, a storage electrode (not shown) that is preferably made of the same layer as the gate lines 121 and overlaps the pixel electrode 190 may be added.

The pixel electrodes 190 overlap the gate lines 121 and the data lines 171 to increase aperture ratio but it is optional.

The contact assistants 81 and 82 are connected to the exposed expansions 129 of the gate lines 121 and the exposed expansions 179 of the data lines 171 through the contact holes 181 and 182, respectively. The contact assistants 81 and 82 are not requisites but preferred to protect the exposed portions 129 and 179 and to complement the adhesiveness of the exposed portions 129 and 179 and external devices.

Since there is no color filter stripe and no black matrix on the common electrode panel 200, the alignment between the TFT array panel 100 and the common electrode panel 200 is insignificant. Accordingly, the substrate 210 can have different physical and chemical characteristics from substrate 110, including but not limited to different concentration, composition, composition rate, and thickness. Therefore, one of the substrates 110 and 210, in particular, the substrate 210 can be selected to have minimized cost. For example, the substrate 210 can be made of plastic or it can have a thickness smaller than the substrate 110.

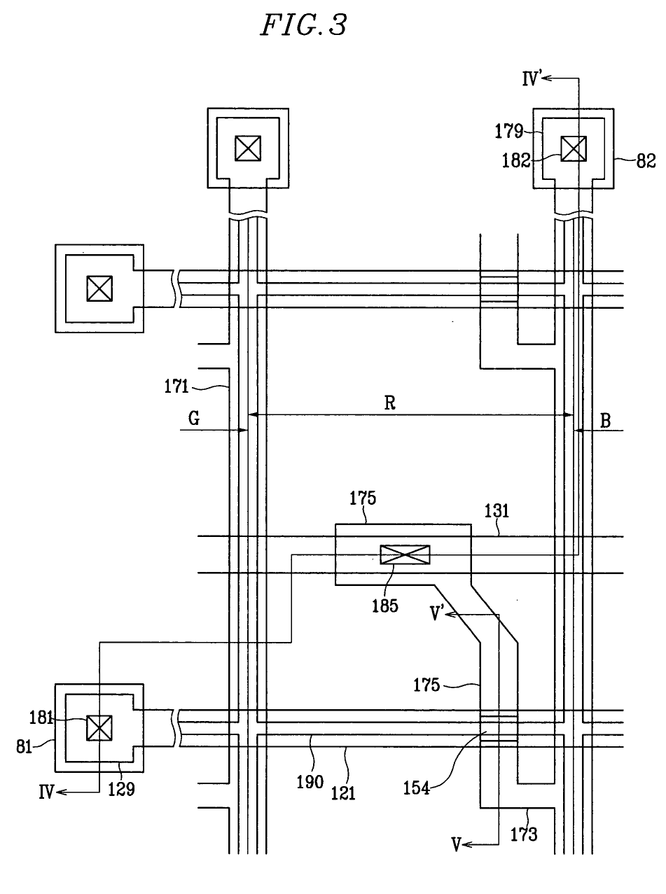

A TFT array panel for an LCD according to another embodiment of the present invention will be described in detail with reference to FIGS. 3-5.

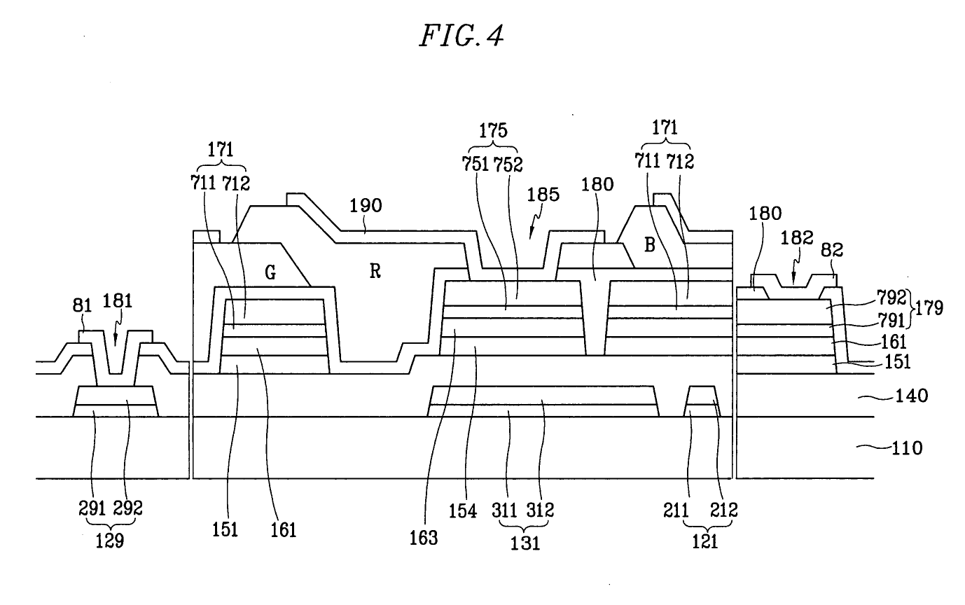

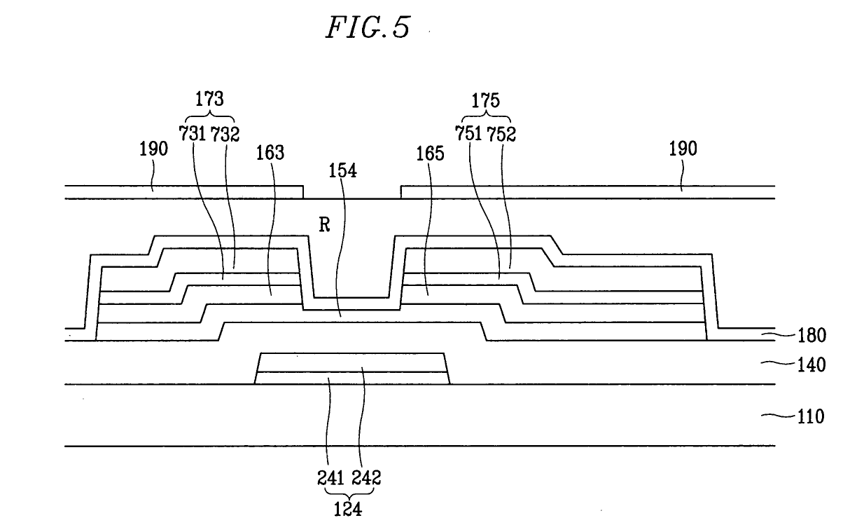

FIG. 3 is a layout view of a TFT array panel for an LCD according to another embodiment of the present invention, FIG. 4 is a sectional view of the TFT array panel shown in FIG. 3 taken along the line IV-IV′, and FIG. 5 is a sectional view of the TFT array panel shown in FIG. 3 taken along the lines V-V′.

Referring to FIGS. 3-5, a layered structure of the TFT array panel according to this embodiment is almost the same as those shown in FIGS. 1 and 2.

That is, a plurality of gate lines 121 including a plurality of gate electrodes 124 and a plurality of storage electrode lines 131 including a plurality of storage electrodes are formed on a substrate 110, and a gate insulating layer 140, a plurality of semiconductor stripes 151 including a plurality of projections 154, and a plurality of ohmic contact stripes 161 including a plurality of projections 163 and a plurality of ohmic contact islands 165, are sequentially formed thereon. A plurality of data lines 171 including a plurality of source electrodes 173 and a plurality of drain electrodes 175 including expansions are formed on the ohmic contacts 161 and 165, and a passivation layer 180 (that corresponds to a first passivation layer 801 shown in FIG. 2) and a plurality of color filter stripes R, G, and B are formed thereon. A plurality of contact holes 181, 182, and 185 are provided at the passivation layer 180 and the gate insulating layer 140, and a plurality of pixel electrodes 190 and a plurality of contact assistants 81 and 82 are formed on the passivation layer 180.

Different from the LCD shown in FIGS. 1 and 2, the TFT array panel according to this embodiment provides a plurality of storage electrode lines 131, which are separated from the gate lines 121, on the same layer as the gate lines 121 without projections. The storage electrode lines 131 include, like the gate lines 121, a lower film 311 and an upper film 312. The storage electrode lines 131 are supplied with a predetermined voltage such as the common voltage. Without providing the storage capacitor conductors 177 shown in FIGS. 1 and 2, the drain electrodes 175 extend to overlap the storage electrode lines 131 to form storage capacitors. The storage electrode lines 131 may be omitted if the storage capacitance generated by the overlapping of the gate lines 121 and the pixel electrodes 190 is sufficient.

The semiconductor stripes 151 have almost the same planar shapes as the data lines 171 and the drain electrodes 175 as well as the underlying ohmic contacts 161 and 165. However, the projections 154 of the semiconductor stripes 151 include some exposed portions, which are not covered with the data lines 171 and the drain electrodes 175, such as portions located between the source electrodes 173 and the drain electrodes 175.

A manufacturing method of the TFT array panel according to an embodiment simultaneously forms the data lines 171, the drain electrodes 175, the semiconductors 151, and the ohmic contacts 161 and 165 using one photolithography process.

A photoresist pattern for the photolithography process has position-dependent thickness, and in particular, it has first and second portions with decreased thickness. The first portions are located on wire areas that will be occupied by the data lines 171, and the drain electrodes 175 and the second portions are located on channel areas of TFTs.

The position-dependent thickness of the photoresist is obtained by several techniques, for example, by providing translucent areas on the exposure mask as well as transparent areas and light blocking opaque areas. The translucent areas may have a slit pattern, a lattice pattern, a thin film(s) with intermediate transmittance or intermediate thickness. When using a slit pattern, it is preferable that the width of the slits or the distance between the slits is smaller than the resolution of a light exposer used for the photolithography. Another example is to use reflowable photoresist. In detail, once a photoresist pattern made of a reflowable material is formed by using a normal exposure mask only with transparent areas and opaque areas, it is subject to reflow process to flow onto areas without the photoresist, thereby forming thin portions.

As a result, the manufacturing process is simplified by omitting a photolithography step.

In addition, there is no passivation layer on the color filter stripes R, G and B. However, the passivation layer 180 may be disposed on the data lines 171 including source electrodes 173 and drain electrodes 175.

Many of the above-described features of the TFT array panel for an LCD shown in FIGS. 1 and 2 may be appropriate to the TFT array panel shown in FIGS. 3-5.

While the present invention has been described in detail with reference to the preferred embodiments, those skilled in the art will appreciate that various modifications and substitutions can be made thereto without departing from the spirit and scope of the present invention as set forth in the appended claims.

What is claimed is:

1. A display device panel, comprising:
a pixel electrode;
a transistor operably coupled to the pixel electrode;
a plurality of signal lines operably coupled to the transistor; and
a plurality of color filter stripes provided between the pixel electrode and the transistor,
wherein the plurality of signal lines and color filter stripes are configured as a black matrix for blocking light leakage between pixels.

2. The panel of claim 1, wherein the pixel electrode is comprised of transparent conductive material.

3. The panel of claim 2, wherein the transparent conductive material is selected from the group consisting of indium tin oxide and indium zinc oxide.

4. The panel of claim 1, wherein the transistor is a thin film transistor.

5. The panel of claim 1, wherein the plurality of signal lines includes a gate line for transmitting scanning signals.

6. The panel of claim 1, wherein the plurality of signal lines includes a data line for transmitting data voltages to the pixel electrode.

7. The panel of claim 1, wherein at least two of the plurality of color filter stripes each represent a different color.

8. The panel of claim 7, wherein the different color is selected from the group consisting of blue, red, and green.

9. The panel of claim 1, wherein at least two of the plurality of color filter stripes overlap each other.

10. The panel of claim 9, wherein the overlap of the at least two color filter stripes is along one of the plurality of signal lines.

11. A thin film transistor array panel, comprising:
an insulating substrate;
a thin film transistor formed over the insulating substrate;
a pixel electrode coupled to the transistor;
at least one gate line coupled to the transistor for transmitting gate signals to the pixel electrode, wherein the at least one gate line extends substantially in a first direction;
at least one data line coupled to the transistor for transmitting data voltages to the pixel electrode, wherein the at least one data line extends substantially in a second direction thereby intersecting the at least one gate line; and
at least two color filter stripes that overlap each other along the at least one data line to block light leakage near a pixel area in a black state.

12. The panel of claim 11, wherein the insulating substrate comprises transparent glass.

13. The panel of claim 11, wherein the pixel electrode is comprised of transparent conductive material.

14. The panel of claim 13, wherein the transparent conductive material is selected from the group consisting of indium tin oxide and indium zinc oxide.

15. The panel of claim 11, wherein the two color filter stripes each represent a different color.

16. The panel of claim 15, wherein the different color is selected from the group consisting of blue, red, and green.

17. The panel of claim 11, wherein the overlap of the at least two color stripes fully covers the data line.

18. The panel of claim 11, further comprising a second data line extending in parallel to the at least one data line.

19. The panel of claim 18, wherein one of the at least two color filter stripes is provided substantially between the at least one data line and the second data line.

20. The panel of claim 11, further comprising a passivation layer formed between the two color filter stripes and the pixel electrode.

21. A liquid crystal display (LCD), comprising:
a first panel including:
a first insulating substrate,
a pixel electrode over the insulating substrate,
a transistor operably coupled to the pixel electrode,
a plurality of signal lines operably coupled to the transistor, and
a plurality of color filter stripes provided between the pixel electrode and the transistor, wherein the plurality of signal lines and color filter stripes are configured as a black matrix for blocking light leakage between pixels;
a second panel including:
a second insulating substrate, and
a common electrode; and
a liquid crystal layer between the first panel and the second panel.

22. The LCD of claim 21, wherein the transistor is a thin film transistor.

23. The LCD of claim 21, wherein the plurality of signal lines includes a gate line for transmitting scanning signals.

24. The LCD of claim 21, wherein the plurality of signal lines includes a data line for transmitting data voltages to the pixel electrode.

25. The LCD of claim 21, wherein at least two of the plurality of color filter stripes represent a different color.

26. The LCD of claim 25, wherein the different color is selected from the group consisting of blue, red, and green.

27. The LCD of claim 21, wherein at least two of the plurality of color filter stripes overlap each other.

28. The LCD of claim 27, wherein the overlap of the at least two color filter stripes is along one of the plurality of signal lines.

29. The LCD of claim 21, wherein the pixel electrode and the common electrode are comprised of transparent conductive material.

30. The LCD of claim 29, wherein the transparent conductive material is selected from the group consisting of indium tin oxide and indium zinc oxide.

31. The LCD of claim 21, wherein the first and second insulating substrates are comprised of different material.

32. The LCD of claim 31, wherein the second insulating substrate is comprised of plastic.

33. The LCD of claim 21, wherein the second insulating substrate is thinner than the first insulating substrate.
